(19) United States
(12) Patent Application Publication
(10) Pub. No.: US 2025/0141544 A1
(43) Pub. Date: May 1, 2025

(54) PATH IDENTIFICATION SYSTEM, PATH IDENTIFICATION METHOD, MONITORING DEVICE, MONITORING DEVICE CONTROL METHOD, AND RECORDING MEDIUM

(71) Applicant: NEC Corporation, Minato-ku, Tokyo (JP)

(72) Inventor: Kohei Nakamura, Tokyo (JP)

(73) Assignee: NEC Corporation, Minato-ku, Tokyo (JP)

(21) Appl. No.: 18/832,747

(22) PCT Filed: Feb. 24, 2022
(86) PCT No.: PCT/JP2022/007489

§ 371 Date: Jul. 24, 2024

(51) Int. Cl. H04B 10/079; H04L 43/0864

(52) U.S. Cl. CPC H04B 10/079; H04L 43/0864

(57) ABSTRACT

A system includes: a path group in which one currently used path can be selected from the paths of optical transmission lines; and a monitor which sends/receives monitoring light to/from the path group, the path group includes: loopback circuits disposed on paths and each loop back monitoring light; a first optical switch that connects one end of one path to a monitor; and a second optical switch that selects another end of one of path; the monitor includes: a monitoring light transmitter that outputs monitoring light to the first optical switch; a monitoring light receiver that receives monitoring light from the first optical switch and outputs wavelength information indicating the wavelength of the received monitoring light; and a controller that identifies a loopback circuit in which the received monitoring light was looped back, and identifies, as the currently used path, the path on which the identified loopback circuit is disposed.

### TECHNICAL FIELD

The present invention relates to a path identification system and the like for use in an optical transmission system.

### BACKGROUND ART

In a transmission system (hereinafter, referred to as an “optical transmission system”) using an optical fiber, there is a case where a configuration including a redundant path on which a plurality of paths (routes) are laid in parallel is adopted in order to secure communication reliability. When a failure has occurred in one path (hereinafter, referred to as an “active path”) in operation, reliability of the optical transmission system can be enhanced by switching, by means of an optical switch, a path of an optical cable in such a way as to set another one of the paths laid in parallel, as an active path. As an optical transmission system including a redundant path, for example, an optical submarine cable system (hereinafter, referred to as an “optical submarine system”) is being operated.

For switching a path of an optical submarine system, an optical switch installed in the ocean floor is used. An active path is configured by performing a switching instruction with respect to the optical switch by a terminal station (hereinafter, referred to as a “land station”) on land. However, generally, an optical switch does not have a function of notifying a land station of a switching state of a path. Therefore, the land station cannot acquire, from the optical switch, information as to which one of a plurality of paths is selected as an active path.

In view of the above, in a general optical submarine system, a monitoring device of a land station transmits monitoring light to an optical cable, measures intensity of the monitoring light looped back from an optical repeater on an active path, and derives a distance from the land station to the optical repeater, based on the intensity. Then, a path being used as the active path is identified by collating the derived distance with an actual distance from the land station to the optical repeater. Alternatively, the land station computes a position of the optical repeater from a position of a reflection point of monitoring light, and identifies, as the active path, a path on which the optical repeater is installed at the computed position. For detection of a position of a reflection point, for example, an optical time domain reflectometer (OTDR) is used.

In association with the present invention, PTL 1 describes an optical amplification repeating device including a function of looping back a main signal.

### CITATION LIST

### Patent Literature

PTL 1: Japanese Unexamined Patent Application Publication No. H5-292038

### SUMMARY OF INVENTION

### Technical Problem

However, when a distance between an optical repeater installed on each of a plurality of redundant paths, and a monitoring device on land is substantially equal, or the like, it cannot be determined which one of the redundant paths is used as an active path from intensity of looped back monitoring light. Further, when a plurality of paths on which a reflection point is present at the same distance are present, even when an OTDR is used, an active path cannot be identified. Specifically, there has been a problem that it may be difficult to identify an active path in a monitoring device of a general optical submarine system having a redundant path.

### OBJECT OF INVENTION

An object of the present invention is to provide a technique for easily identifying an active path in an optical transmission system having a redundant path.

### Solution to Problem

A path identification system according to the present invention includes:

a path group being capable of selecting one active path from among paths being a plurality of optical transmission paths disposed in parallel; and

a monitoring means for transmitting and receiving monitoring light to and from the path group, wherein

the path group includes
a loopback means, disposed on each of the plurality of paths, for looping back only monitoring light of a wavelength being different from each other,
a first optical switching means for connecting any of one end of the plurality of paths to the monitoring means, and
a second optical switching means for selecting any of the other end of the plurality of paths, and

the monitoring means includes
a monitoring light transmission means for outputting the monitoring light to the first optical switching means,
a monitoring light reception means for receiving the monitoring light from the first optical switching means, and outputting wavelength information indicating a wavelength of the received monitoring light, and
a control means for identifying the loopback means in which the received monitoring light is looped back, based on the wavelength information, and loopback information in which a wavelength of the monitoring light to be looped back by the plurality of loopback means is recorded, and identifying, as the active path, a path on which the identified loopback means is disposed.

A monitoring device according to the present invention includes:

a monitoring light transmission means for outputting monitoring light to an optical transmission path;

a monitoring light reception means for receiving the monitoring light, and outputting wavelength information indicating a wavelength of the received monitoring light; and

a control means for holding loopback information in which a wavelength of the monitoring light to be looped back by a plurality of loopback means on the optical transmission path is recorded, identifying the loopback means in which the received monitoring light is looped back, based on the wavelength information and the loopback information, and identifying, as an active path, a path on which the identified loopback means is disposed.

A path identification method according to the present invention is a path identification method for use in an optical transmission system including a path group being capable of selecting one active path from among paths being a plurality of optical transmission paths disposed in parallel, and a monitoring means for transmitting and receiving monitoring light to and from the path group, the path identification method including:

connecting any of one end of the plurality of paths to the monitoring means by a first optical switching means;

selecting any of the other end of the plurality of paths by a second optical switching means;

outputting the monitoring light to the first optical switching means;

looping back only the monitoring light of a wavelength being different from each other by a loopback means on each of the plurality of paths;

receiving the monitoring light from the first optical switching means, and outputting wavelength information indicating a wavelength of the received monitoring light;

identifying the loopback means in which the received monitoring light is looped back, based on the wavelength information, and loopback information in which a wavelength of the monitoring light to be looped back by the plurality of loopback means is recorded; and

identifying, as the active path, a path on which the identified loopback means is disposed.

A monitoring device control method according to the present invention includes procedures of:

outputting monitoring light to an optical transmission path;

receiving the monitoring light;

outputting wavelength information indicating a wavelength of the received monitoring light; and

identifying a loopback means in which the received monitoring light is looped back, based on loopback information in which a wavelength of the monitoring light to be looped back by a plurality of the loopback means on the optical transmission path is recorded, and the wavelength information, and identifying, as an active path, a path on which the identified loopback means is disposed.

A recording medium according to the present invention is recorded with a program for causing a computer of a monitoring device to execute:

a procedure of outputting monitoring light to an optical transmission path;

a procedure of receiving the monitoring light;

a procedure of outputting wavelength information indicating a wavelength of the received monitoring light;

a procedure of recording, as loopback information, a wavelength of the monitoring light to be looped back by a plurality of loopback means on the optical transmission path;

a procedure of identifying the loopback means in which the received monitoring light is looped back, based on the loopback information and the wavelength information; and

a procedure of identifying, as an active path, a path on which the identified loopback means is disposed.

### EFFECTS OF INVENTION

The present invention provides a technique for easily identifying an active path in an optical transmission system having a redundant path.

### BRIEF DESCRIPTION OF DRAWINGS

FIG. 1 is a block diagram illustrating a configuration example of an optical submarine system according to a first example embodiment.

FIG. 2 is a block diagram illustrating a configuration example of a monitoring device.

FIG. 3 is a diagram illustrating a configuration example of an optical repeater according to the first example embodiment.

FIG. 4 is a table illustrating an example of a transmission wavelength of an optical band pass filter.

FIG. 5 is a block diagram illustrating a configuration example of the monitoring device applicable to the optical submarine system according to the first example embodiment.

FIG. 6 is a block diagram illustrating an example of a minimum configuration of the optical submarine system.

FIG. 7 is a block diagram illustrating a configuration example of an optical submarine system according to a second example embodiment.

FIG. 8 is a block diagram illustrating a configuration example of an optical repeater.

FIG. 9 is a block diagram illustrating a configuration example of an optical submarine system according to a third example embodiment.

FIG. 10 is a table illustrating an example of a transmission wavelength of an optical band pass filter.

FIG. 11 is a diagram illustrating a configuration example of an optical submarine system according to a fourth example embodiment.

FIG. 12 is a table illustrating an example of a transmission wavelength of an optical band pass filter in each optical repeater.

FIG. 13 is a diagram describing an optical submarine system being a modification example of the fourth example embodiment.

FIG. 14 is a table illustrating an example of a transmission wavelength of an optical band pass filter in each optical repeater.

### EXAMPLE EMBODIMENT

Hereinafter, example embodiments according to the present invention are described with reference to the drawings. An arrow in each drawing is indicated as an example for describing a direction of a signal or the like in the example embodiments, and does not mean limitation of a direction. Further, unless otherwise specifically mentioned by a black circle mark or the like, an intersection of lines does not mean combining signals or the like in which a direction is different. In each drawing, an already described element is indicated with a same name and reference sign, and overlapping description is omitted in each example embodiment.

### First Example Embodiment

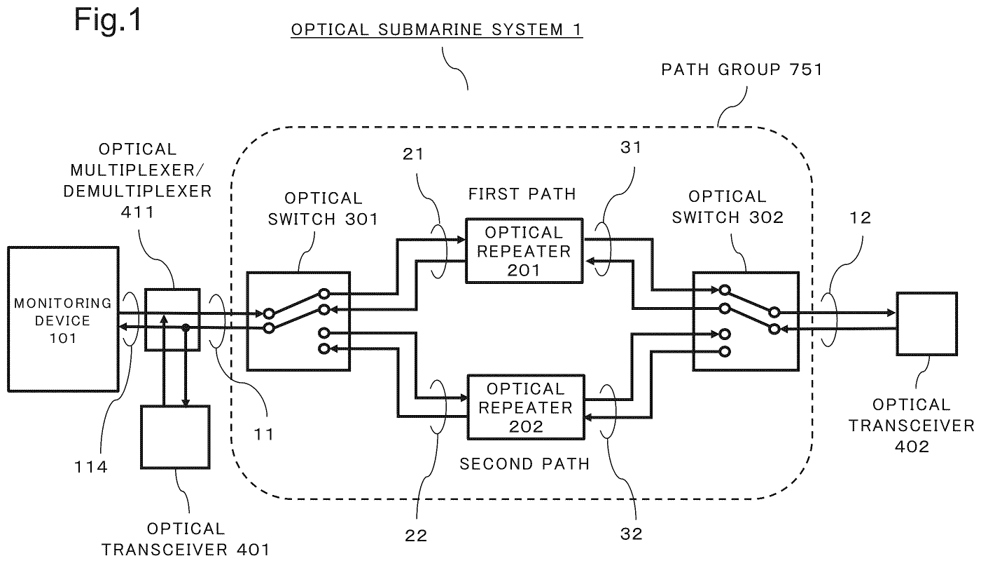

FIG. 1 is a block diagram illustrating a configuration example of an optical submarine system 1 according to a first example embodiment. The optical submarine system 1 includes a monitoring device 101, optical repeaters 201 and 202, optical switches 301 and 302, optical transceivers 401 and 402, and an optical multiplexer/demultiplexer 411. A fiber pair (FP) in which two optical fibers constitute a pair connects between these elements. Each of the optical fibers of one fiber pair transmits light in an opposite direction to each other. Each of the fiber pairs is an optical transmission path of the optical submarine system 1. In FIG. 1, a configuration having a redundant path including the optical repeaters 201 and 201, and the optical switches 301 and 302 is described as a path group 751.

A fiber pair 11 connects between the optical multiplexer/demultiplexer 411 and the optical switch 301. A fiber pair 12 connects between the optical transceiver 402 and the optical switch 302. Each of the optical switches 301 and 302 is, for example, a 2×4 optical switch. The optical switches 301 and 302 are switched in such a way that the fiber pair 11 and the fiber pair 12 are connected to each other by a first path or a second path. The first path is a path along which the fiber pair 11 and the fiber pair 12 are connected via the optical switch 301, a fiber pair 21, the optical repeater 201, a fiber pair 31, and the optical switch 302. The second path is a path along which the fiber pair 11 and the fiber pair 12 are connected via the optical switch 301, a fiber pair 22, the optical repeater 202, a fiber pair 32, and the optical switch 302. In this way, the optical switches 301 and 302 select an active path from among a plurality of paths (the first path and the second path).

The monitoring device 101 sends generated monitoring light to one of optical fibers of a fiber pair 114. The monitoring light is looped back in a loopback circuit disposed within the optical submarine system 1. The loopback circuit is described later. The monitoring device 101 receives the looped back monitoring light from the other of the optical fibers of the fiber pair 114. The optical transceivers 401 and 402 transmit and receive a user signal to be transmitted by the optical submarine system 1. For example, the optical transceiver 401 transmits a user signal to the optical transceiver 402 by using wavelength division multiplexing (WDM) signal light, and receives WDM signal light transmitted by the optical transceiver 402. Hereinafter, WDM signal light is simply described as “signal light”. The optical transceiver 402 transmits another user signal to the optical transceiver 401 by using signal light, and receives signal light transmitted by the optical transceiver 401. Wavelengths of these beams of signal light do not overlap a wavelength of monitoring light.

The optical multiplexer/demultiplexer 411 multiplexes (wavelength multiplexes) and demultiplexes (wavelength demultiplexes) monitoring light to be transmitted and received in the monitoring device 101, and signal light to be transmitted and received in the optical transceiver 401. Specifically, the optical multiplexer/demultiplexer 411 multiplexes monitoring light input from the monitoring device 101 and signal light input from the optical transceiver 401, and outputs the multiplexed light to the optical switch 301. Further, light in which signal light output by the optical transceiver 402, and monitoring light looped back in the optical submarine system 1 are multiplexed is input to the optical multiplexer/demultiplexer 411 from the optical switch 301. The optical multiplexer/demultiplexer 411 demultiplexes signal light and monitoring light input from the optical switch 301. The optical multiplexer/demultiplexer 411 outputs demultiplexed monitoring light to the monitoring device 101, and outputs demultiplexed signal light to the optical transceiver 401.

The fiber pair 11 is connected to two ports of the optical switch 301 on a side of the optical multiplexer/demultiplexer 411. The fiber pairs 21 and 22 are connected to four ports of the optical switch 301 on the opposite side thereof. When the optical switch 301 is in a first state, the fiber pair 11 is connected to the fiber pair 21. When the optical switch 301 is in a second state, the fiber pair 11 is connected to the fiber pair 22.

Further, the fiber pair 12 is connected to two ports of the optical switch 302 on a side of the optical transceiver 401. The fiber pairs 31 and 32 are connected to four ports of the optical switch 302 on the opposite side thereof. When the optical switch 302 is in the first state, the fiber pair 12 is connected to the fiber pair 31. When the optical switch 301 is in the second state, the fiber pair 12 is connected to the fiber pair 32. FIG. 1 illustrates a case where both of the optical switch 301 and the optical switch 302 are in the first state, and consequently, the optical switch 301 and the optical switch 302 are connected to each other by the first path.

The optical switches 301 and 302 are controlled by a control signal. A control signal controls the optical switches 301 and 302 in such a way that an optical path between the optical switch 301 and the optical switch 302 becomes either the first path or the second path. Specifically, the optical switches 301 and 302 are controlled in such a way that both thereof are in the first state, or both thereof are in the second state. The monitoring device 101 may transmit a control signal by using a control channel. Alternatively, the optical transceiver 401 or 402 may transmit a control signal by using a control channel included in signal light to be transmitted. The optical switches 301 and 302 may include an optical tap capable of splitting light included in a control signal. In this case, the optical switches 301 and 302 extract a control signal from light split from the optical tap.

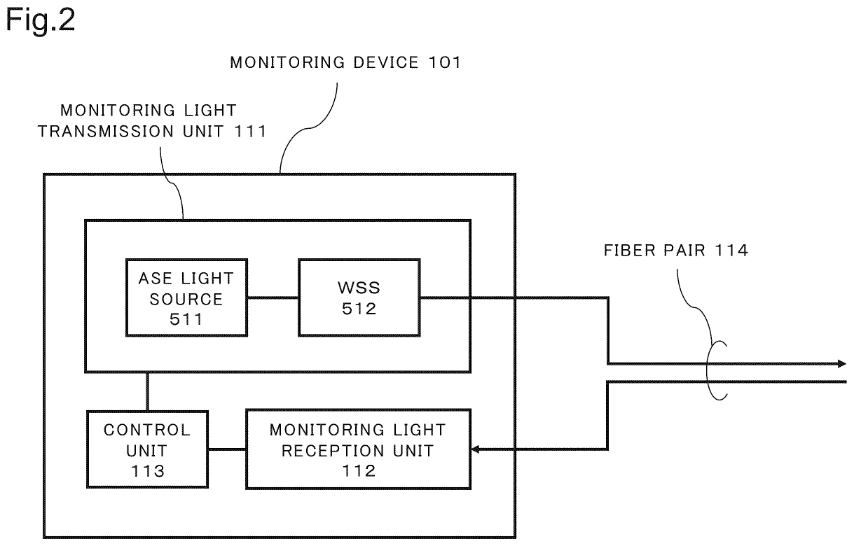

FIG. 2 is a block diagram illustrating a configuration example of the monitoring device 101. The monitoring device 101 includes a monitoring light transmission unit 111, a monitoring light reception unit 112, and a control unit 113. The monitoring light transmission unit 111 outputs (transmits) monitoring light of a predetermined wavelength to one of optical fibers of the fiber pair 114. The monitoring light transmission unit 111 includes an amplified spontaneous emission (ASE) light source 511 and a wavelength selective switch (WSS) 512. The ASE light source 511 generates natural emission light of a broadband. For example, ASE is generated by inputting excitation light to an optical fiber for optical amplification. The WSS 512 is an optical device capable of controlling, from outside, a transmission band and an attenuation amount. The WSS 512 may be controlled from the control unit 113. Inputting an output of the ASE light source 511 to the WSS 512, and setting, as a wavelength of monitoring light 701, a transmission band of the WSS allows the monitoring light transmission unit 111 to generate monitoring light of a predetermined wavelength. Alternatively, monitoring light may be generated by a wavelength variable light source. Further, the monitoring light transmission unit 111 may transmit a control signal for controlling the optical switches 301 and 302.

The monitoring light reception unit 112 receives looped back monitoring light from the other of the optical fibers of the fiber pair 114. The monitoring light reception unit 112 measures a spectrum of received monitoring light, and outputs, to the control unit 113, wavelength information indicating a wavelength of the received light. The monitoring light reception unit 112 may include a general light spectrum analyzer or spectrometer. The control unit 113 controls the monitoring light transmission unit 111 and the monitoring light reception unit 112.

A maintenance person applies setting necessary for an operation of the monitoring device 101 to the control unit 113. Alternatively, a management device administrating the entirety of the optical submarine system 1 may remotely perform setting for the control unit 113.

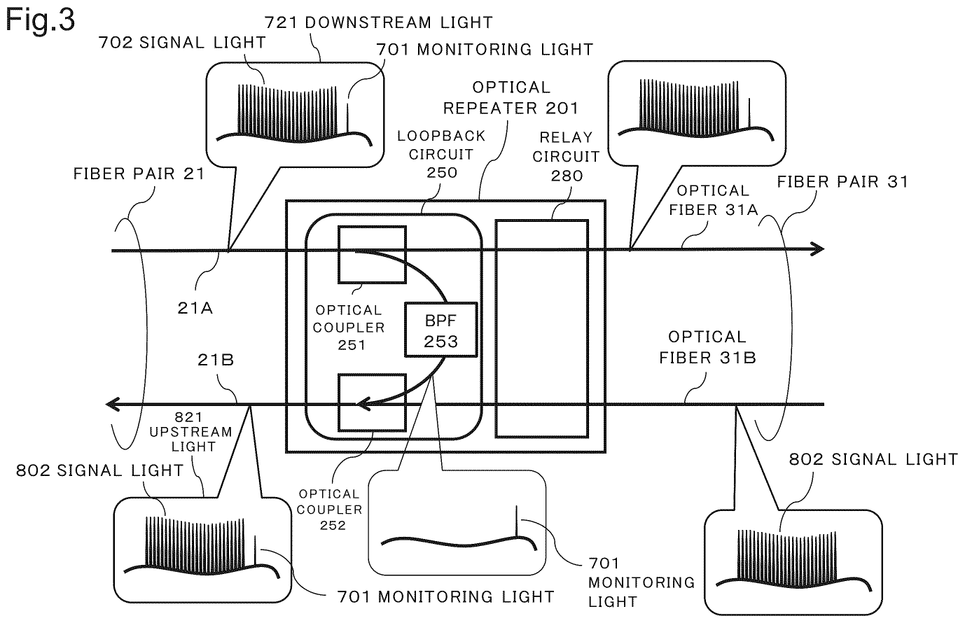

FIG. 3 is a diagram illustrating a configuration example of the optical repeater 201 according to the first example embodiment. The optical repeaters 201 and 202 include a relay circuit 280 and a loopback circuit 250. The relay circuit 280 includes a general function (e.g., a monitoring function of an optical repeater and an amplification function of an optical signal) for relaying an optical signal. Since the general function of the relay circuit 280 is known, description thereof is omitted. Further, a configuration of the relay circuit 280 and the loopback circuit 250 included in each of the optical repeaters 201 and 202 is common except for a transmission wavelength of an optical band pass filter 253 to be described later. Therefore, in FIG. 3 and thereafter, the optical repeater 201 is described.

The fiber pair 21 and the fiber pair 31 are connected to the optical repeater 201. The fiber pair 21 includes optical fibers 21A and 21B. The fiber pair 31 includes optical fibers 31A and 31B. Light propagating through the optical fiber 21A is input to the loopback circuit 250. Light propagating through the optical fiber 31B is processed by the relay circuit 280, and then, input to the loopback circuit 250. FIG. 3 illustrates together with an example of a spectrum of light propagating through the fiber pairs 21 and 31. A horizontal axis of the spectrum denotes a wavelength, and a vertical axis thereof denotes intensity. However, the spectrum in FIG. 3 schematically illustrates an example of a relationship of a wavelength between signal light and monitoring light.

The optical fiber 21A transmits downstream light 721 including the monitoring light 701 and signal light. The monitoring light 701 is transmitted from the monitoring device 101. Signal light 702 is transmitted from the optical transceiver 401. A wavelength of the monitoring light 701 does not overlap a wavelength of the signal light 702. The optical fiber 31B transmits signal light 802 transmitted from the optical transceiver 402. A wavelength of the signal light 802 does not overlap a wavelength of the monitoring light 701.

The loopback circuit 250 includes optical couplers 251 and 252, and the optical band pass filter (BPF) 253. The optical couplers 251 and 252 are an optical directional coupler. The optical coupler 251 splits the downstream light 721 input from the optical fiber 21A into two beams of light. One beam of light 212 of the two beams of split light is output to the optical band bass filter 253. The other beam of the light split by the optical coupler 251 is input to the relay circuit 280. The relay circuit 280 performs general relay processing for the downstream light 721 input from the optical coupler 251, and outputs the processed light to the optical fiber 31A.

The optical band pass filter 253 is an optical filter transmitting only a part of wavelengths of the downstream light 721 input from the optical coupler 251, and outputting the transmitted light to the optical coupler 252. Specifically, the optical band pass filter 253 transmits only monitoring light of a predetermined wavelength among a wavelength band for use in the monitoring light 701, and blocks light of a wavelength other than the above.

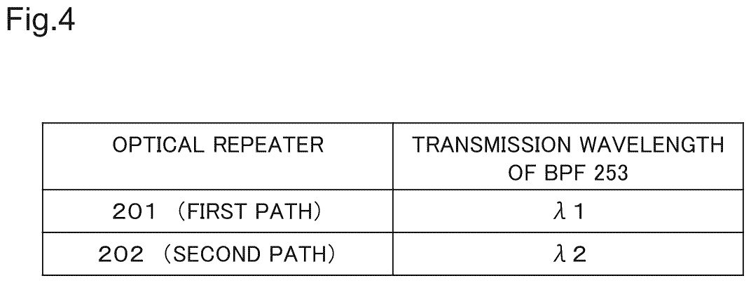

FIG. 4 is a table illustrating an example of a transmission wavelength of the optical band pass filter 253. A transmission wavelength of the optical band pass filter 253 is different for each optical repeater disposed in parallel. In the present example embodiment, a transmission wavelength of the optical band pass filter 253 included in the optical repeater 201 is λ1, and a transmission wavelength of the optical band pass filter 253 included in the optical repeater 202 is λ2. λ1 and λ2 are included in the wavelength band for use in the monitoring light 701. Further, λ1 and λ2 are different from each other. The optical coupler 252 combines the monitoring light 701 transmitted through the optical band pass filter 253, and the signal light 802 transmitted from the optical fiber 31B. The combined light is output to the optical fiber 21B, as upstream light 821. Specifically, a transmission wavelength of the optical band pass filter 253 indicates a wavelength of monitoring light to be looped back by the loopback circuit 250.

Note that, a WSS may be used as the optical band pass filter 253. Allowing a transmission wavelength of a WSS of the optical band pass filter 253 to be controlled by a control signal from a land device enables to change a wavelength of monitoring light to be looped back during operation of the optical submarine system 1. Alternatively, each of the optical couplers 251 and 252 may be replaced with an optical multiplexer/demultiplexer for multiplexing and demultiplexing only a wavelength of monitoring light. In this case, the optical band pass filter 253 can be omitted.

In this way, the monitoring light 701 of a wavelength to pass through the optical band pass filter 253 is inserted to the upstream light 821 to be transmitted through the optical fiber 21B. Specifically, the upstream light 821 includes the monitoring light 701, and the signal light 802 processed by the relay circuit 280. When light of a wavelength to pass through the optical band pass filter 253 is not present, only the signal light 802 is included in the upstream light 821. The loopback circuit 250 is installed on each of the first path and the second path being a plurality of paths, and loops back only monitoring light of a wavelength being different from each other.

The upstream light 821 propagating through the optical fiber 21B is input to the optical multiplexer/demultiplexer 411 via the optical switch 301 in FIG. 1. The optical multiplexer/demultiplexer 411 demultiplexes the upstream light 821 into the monitoring light 701 and the signal light 802. The signal light 802 is received by the optical transceiver 401. The monitoring light 701 is received by the monitoring light reception unit 112 of the monitoring device 101.

The control unit 113 holds data on a transmission wavelength of the optical band pass filter 253 illustrated in FIG. 4. Then, the monitoring light reception unit 112 notifies the control unit 113 of the wavelength, when receiving the monitoring light 701. Since a transmission wavelength of the optical band pass filter 253 is different for each optical repeater, the control unit 113 can identify an optical repeater in which the monitoring light 701 is looped back by collating data on the transmission wavelength in FIG. 4 with the wavelength of the monitoring light 701 notified from the monitoring light reception unit 112.

For example, when the monitoring light reception unit 112 receives monitoring light of the wavelength λ1 after the monitoring light transmission unit 111 transmits the monitoring light 701 of the wavelength λ1, it is indicated that the monitoring light 701 is looped back in the optical repeater 201. Therefore, in this case, the control unit 113 can determine that the optical switch 301 selects the first path.

Further, when the monitoring light reception unit 112 does not receive monitoring light after the monitoring light transmission unit 111 transmits the monitoring light 701 of the wavelength λ1, there is a possibility that the monitoring light 701 is looped back in a repeater other than the optical repeater 201. There is also a possibility that a failure is present on a path along which the monitoring light 701 is transmitted. In this case, the monitoring device 101 may transmit monitoring light of the wavelength λ2. When the monitoring light reception unit 112 receives monitoring light of the wavelength λ2 after the monitoring light transmission unit 111 transmits the monitoring light 701 of the wavelength λ2, it is indicated that the monitoring light 701 is looped back in the optical repeater 202. Therefore, in this case, the control unit 113 can determine that the optical switch 301 selects the second path. In this way, the optical submarine system 1 according to the present example embodiment achieves an advantageous effect that an active path can be identified in an optical transmission system having a redundant path. Further, the optical submarine system 1 achieving an advantageous effect as described above can be referred to as a path identification system.

Note that, the loopback circuit 250 may be incorporated in the optical repeater 201, or may be added in such a way as to be expanded to the outside of a general optical repeater including the relay circuit 280. Configuring the loopback circuit 250 in such a way as to be able to be expanded to a general optical repeater enables to add the above-described loopback function to an existing general optical repeater.

Further, the loopback circuit 250 can be disposed on at least one of a fiber pair 21 side and a fiber pair 31 side of the relay circuit 280. In FIG. 1, the loopback circuit 250 may be disposed at least one of between the optical repeater 201 and the optical switch 301, and between the optical repeater 201 and the optical switch 302.

### Modification Example of First Example Embodiment

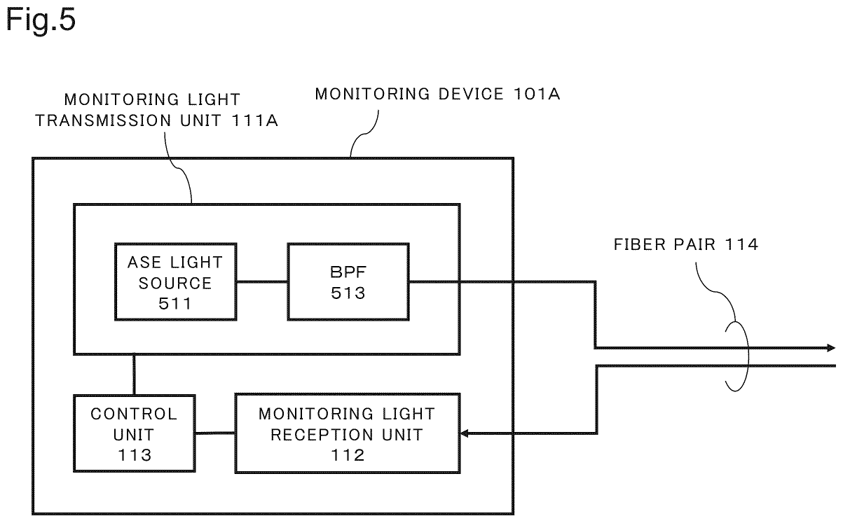

FIG. 5 is a block diagram illustrating a configuration example of a monitoring device 101A applicable to the optical submarine system 1 according to the first example embodiment. The monitoring device 101A is used in place of the monitoring device 101 in FIG. 1.

The monitoring device 101A includes a monitoring light transmission unit 111A, in place of the monitoring light transmission unit 111 of the monitoring device 101. The monitoring light transmission unit 111A includes an ASE light source 511 and an optical band pass filter (BPF) 513. The ASE light source 511 generates natural emission light of a broadband. The optical band pass filter 513 transmits only ASE light of a wavelength band (monitoring light band) for use as monitoring light 701. The WSS 512 in FIG. 2 may be used as the optical band pass filter 513.

In the present example embodiment, a continuous band including wavelengths λ1 and λ2 is set as a transmission band in the optical band pass filter 513. The transmission band is a band that does not overlap a wavelength band of signal light 702 and 802. According to such a configuration, the monitoring device 101A sends, as the monitoring light 701, ASE light including the wavelengths λ1 and λ2. An optical band pass filter 253 included in each of optical repeaters 201 and 202 transmits only light of the wavelength λ1 or λ2. Therefore, when an optical switch 301 selects a first path, a monitoring light reception unit 112 receives the monitoring light 701 of the wavelength λ1, and when the optical switch 301 selects a second path, the monitoring light reception unit 112 receives monitoring light of the wavelength λ2. Specifically, using the monitoring device 101A allows a control unit 113 to identify an active path by sending ASE light having a wavelength band of monitoring light only once.

### Minimum Configuration of First Example Embodiment

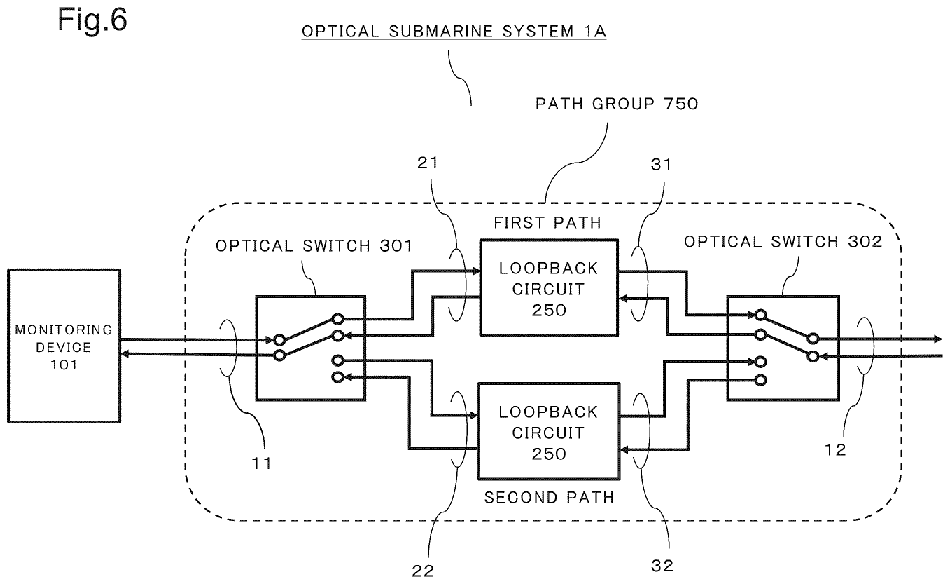

FIG. 6 is a block diagram illustrating an example of a minimum configuration of the optical submarine system 1 according to the first example embodiment. An advantageous effect that an active path can be identified in an optical transmission system having a redundant path is also acquired by an optical submarine system 1A illustrated in FIG. 6.

The optical submarine system 1A includes a monitoring device 101 (monitoring means) and a path group 750. The monitoring device 101 plays a role as a monitoring means for transmitting and receiving monitoring light to and from the path group 750. The path group 750 includes a configuration capable of selecting one active path from among paths being a plurality of optical transmission paths disposed in parallel.

The path group 750 includes two loopback circuits 250, and optical switches 301 and 302. The two loopback circuits 250 are connected to the optical switches 301 and 302 by an optical transmission path. The optical switch 301 plays a role as a first optical switching means for connecting any of one end of the plurality of paths to the monitoring device 101. The optical switch 302 plays a role as a second optical switching means for selecting any of the other end of the plurality of paths. Specifically, the optical switches 301 and 302 select an active path from among the plurality of paths. The loopback circuit 250 plays a role as a loopback means, installed on each of the plurality of paths, for looping back only monitoring light of a wavelength being different from each other.

As illustrated in FIG. 2, the monitoring device 101 includes a monitoring light transmission unit 111, a monitoring light reception unit 112, and a control unit 113. The monitoring light transmission unit 111 plays a role as a monitoring light transmission means for outputting monitoring light to the optical switch 301. The monitoring light reception unit 112 plays a role as a monitoring light reception means for receiving monitoring light from the optical switch 302, and outputting wavelength information indicating a wavelength of the received monitoring light. The control unit 113 identifies the loopback circuit 250 in which received monitoring light is looped back, and identifies, as an active path, a path on which the identified loopback circuit 250 is disposed. The control unit 113 as described above can be referred to as a control means. Herein, the control unit 113 identifies the loopback circuit 250 in which received monitoring light is looped back, based on wavelength information, and loopback information in which a wavelength of monitoring light to be looped back by a plurality of the loopback circuits 250 is recorded.

The optical submarine system 1A and the monitoring device 101 having a configuration as described above also achieves an advantageous effect that an active path can be identified in an optical transmission system having a redundant path.

### Second Example Embodiment

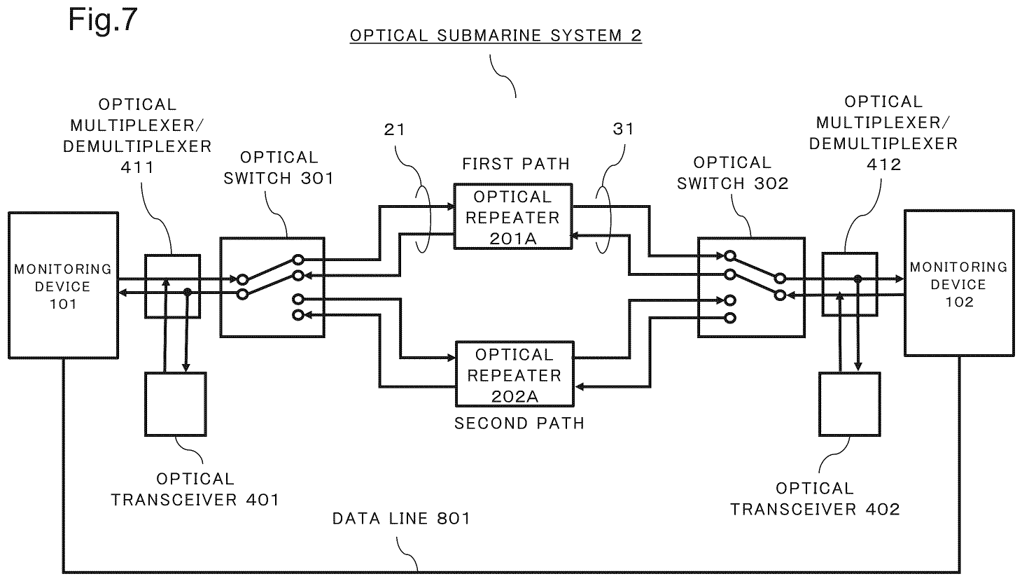

FIG. 7 is a block diagram illustrating a configuration example of an optical submarine system 2 according to a second example embodiment.

As compared with the optical submarine system 1 in FIG. 1, the optical submarine system 2 includes optical repeaters 201A and 202A, and also includes a monitoring device 102, and an optical multiplexer/demultiplexer 412. Each of the monitoring device 102 and the optical multiplexer/demultiplexer 412 provides, on a side of an optical switch 302, a function similar to that of a monitoring device 101 and an optical multiplexer/demultiplexer 411. Specifically, the monitoring device 102 outputs monitoring light to the optical repeaters 201A and 202A, and receives the monitoring light looped back in these optical repeaters. The monitoring device 102 identifies an optical repeater in which monitoring light is looped back, based on a wavelength of the looped back monitoring light. The optical multiplexer/demultiplexer 412 multiplexes and demultiplexes monitoring light to be transmitted and received by the monitoring device 102, and signal light to be transmitted and received by an optical transceiver 402.

The monitoring device 101 and the monitoring device 102 are connected to each other by a data line 801. The data line 801 may be a line communicably connecting the monitoring device 101 and the monitoring device 102 via a first path or a second path. The data line 801 transmits and receives data indicating an identification result of a path between the monitoring devices 101 and 102.

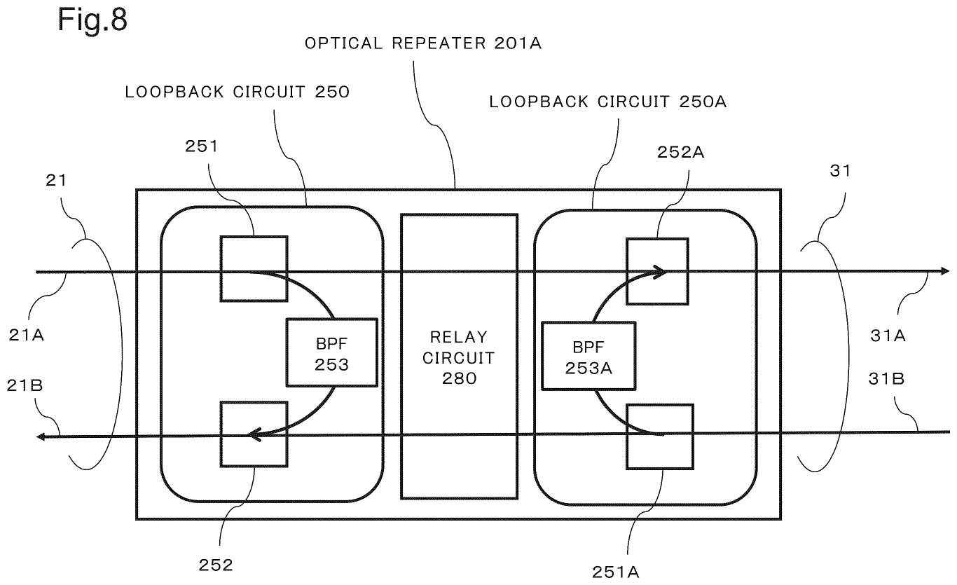

FIG. 8 is a block diagram illustrating a configuration example of the optical repeater 201A. The optical repeater 201A includes loopback circuits 250 and 250A, and a relay circuit 280. As described in the first example embodiment, the loopback circuit 250 loops back monitoring light input from a fiber pair 21. In contrast, the loopback circuit 250A loops back, to a fiber pair 31, monitoring light input from the fiber pair 31 by using a configuration and a procedure similar to those of the loopback circuit 250. Specifically, an optical coupler 251A splits light input from an optical fiber 31B to the optical repeater 201A. An optical band pass filter 253A transmits only light of a predetermined wavelength. An optical coupler 252A combines signal light to be transmitted from an optical fiber 21A to an optical fiber 31A, and light input from the optical bandpass filter 253A, and outputs the combined light to the optical fiber 31A.

The optical repeater 201A having a configuration as described above can loop back, to the monitoring device 101, monitoring light transmitted from the monitoring device 101 disposed on a side of an optical switch 301. Further, the optical repeater 201A can loop back, to the monitoring device 102, monitoring light transmitted from the monitoring device 102 disposed on a side of the optical switch 302.

The optical repeater 202A includes a configuration similar to that of the optical repeater 201A. However, a transmission wavelength of an optical band pass filter 253 of the optical repeater 202A is different from a transmission wavelength of the optical band pass filter 253 of the optical repeater 201A. Further, a transmission wavelength of the optical band pass filter 253A of the optical repeater 202A is different from a transmission wavelength of the optical band pass filter 253A of the optical repeater 201A.

Each of the monitoring devices 101 and 102 identifies a path selected by the optical switch 301 or 302, based on a wavelength of looped back monitoring light. Therefore, the optical submarine system 2 according to the present example embodiment achieves an advantageous effect that a selected path can be identified regarding both of the optical switches 301 and 302. Note that, each of the monitoring devices 101 and 102 may transmit monitoring light in a different time period. Each of the monitoring devices 101 and 102 transmits monitoring light in a time period not overlapping each other. This enables to suppress, for example, erroneous determination on an active line due to reception of monitoring light transmitted from the monitoring device 101 by the monitoring device 102. Note that, a transmission wavelength of the optical band pass filters 253 and 253A included in the optical submarine system 2 may all be different from each other. In this case, even when the monitoring devices 101 and 102 transmit monitoring light at the same time, the monitoring devices 101 and 102 can identify an optical repeater in which received monitoring light is looped back.

Further, each of identification results may be shared between the monitoring devices 101 and 102 by using the data line 801. Sharing an identification result allows the monitoring devices 101 and 102 to determine whether a path identified by each of the monitoring devices 101 and 102 coincides with each other. When a path identified in the monitoring device 101, and a path identified in the monitoring device 102 coincide with each other, the monitoring device 101 or 102 can determine that both of the optical switch 301 and the optical witch 302 are switched in such a way as to configure the same path. Further, when an identified path does not coincide with each other between the monitoring device 101 and the monitoring device 102, the monitoring device 101 or 102 can determine that there is a possibility that the optical switch 301 or the optical switch 302 is switched in such a way as to select a different path by mistake. Specifically, the optical submarine system 2 according to the present example embodiment can detect an anomaly occurring in a case where the optical switch 301 or 302 performs an action being different from expectation.

### Third Example Embodiment

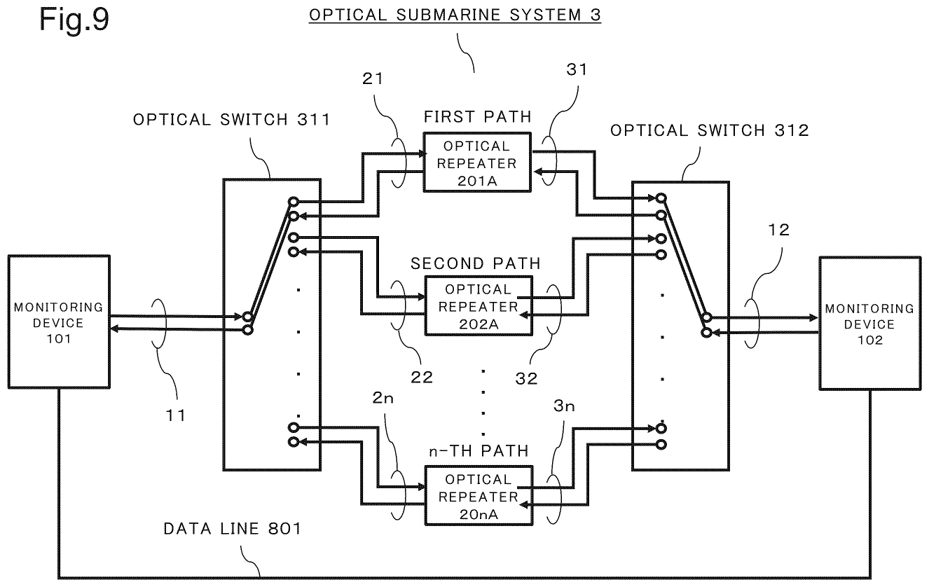

FIG. 9 is a block diagram illustrating a configuration example of an optical submarine system 3 according to a third example embodiment. The optical submarine system 3 is different from the optical submarine system 2 in a point that n paths are disposed in parallel. n is an integer of 2 or more. FIG. 7 in the second example embodiment is equivalent to a case where n=2. Further, in FIG. 9, description on the optical transceivers 401 and 402, and the optical multiplexer/demultiplexers 411 and 412 in FIG. 7 is omitted.

The optical submarine system 3 includes a first path to a n-th path between optical switches 311 and 312. The optical switches 311 and 312 are connected to each other by any one of the first path to the n-th path. Optical repeaters 201A, 202A, . . . , and 20nA indicate n optical repeaters disposed in parallel. Each of these optical repeaters include a configuration similar to that of the optical repeater 201A described in FIG. 8.

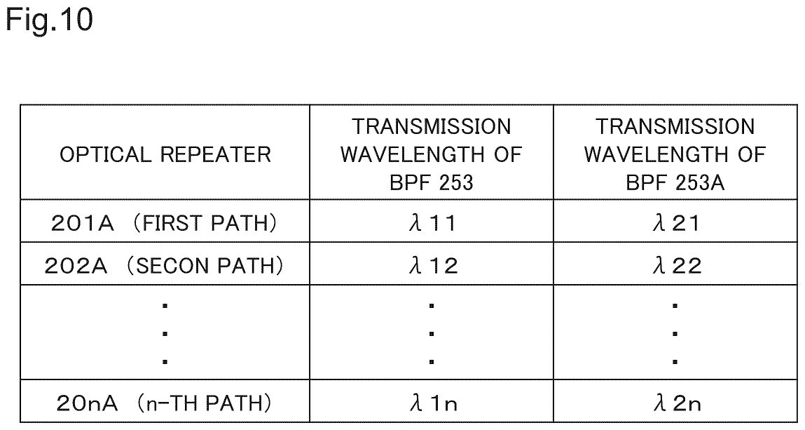

FIG. 10 is a table illustrating an example of a transmission wavelength of optical band pass filters 253 and 253A in the present example embodiment. A transmission wavelength of the optical band pass filter 253 is different for each optical repeater. A transmission wavelength of the optical band pass filter 253 included in the optical repeaters 201A to 20nA is each λ11 to λ1n, and λ11 to λ1n are different from one another. Further, a transmission wavelength of the optical band pass filter 253A is each λ21 to λ2n, and λ21 to λ2n are different from one another. Therefore, for example, when a wavelength of monitoring light received in a monitoring device 101 is λ13, and a wavelength of monitoring light received in a monitoring device 102 is λ23, it is possible to identify that both of the optical switches 311 and 312 select a third path. Further, when a different path is identified between the optical switch 301 and the optical switch 302, the monitoring device 101 or 102 can determine that an anomaly has occurred in at least one of the optical switches 301 and 302. Further, λ11 to λ1n, and λ21 to λ2n may all be different from one another.

In this way, the optical submarine system 3 according to the present example embodiment can identify a path being selected by an optical switch, even when three or more paths are disposed in parallel. A reason for this is that a wavelength of monitoring light to be looped back is different in each of optical repeaters disposed in parallel. This allows the monitoring devices 101 and 102 to identify an optical repeater in which monitoring light is looped back, based on a wavelength of the looped back monitoring light.

### Fourth Example Embodiment

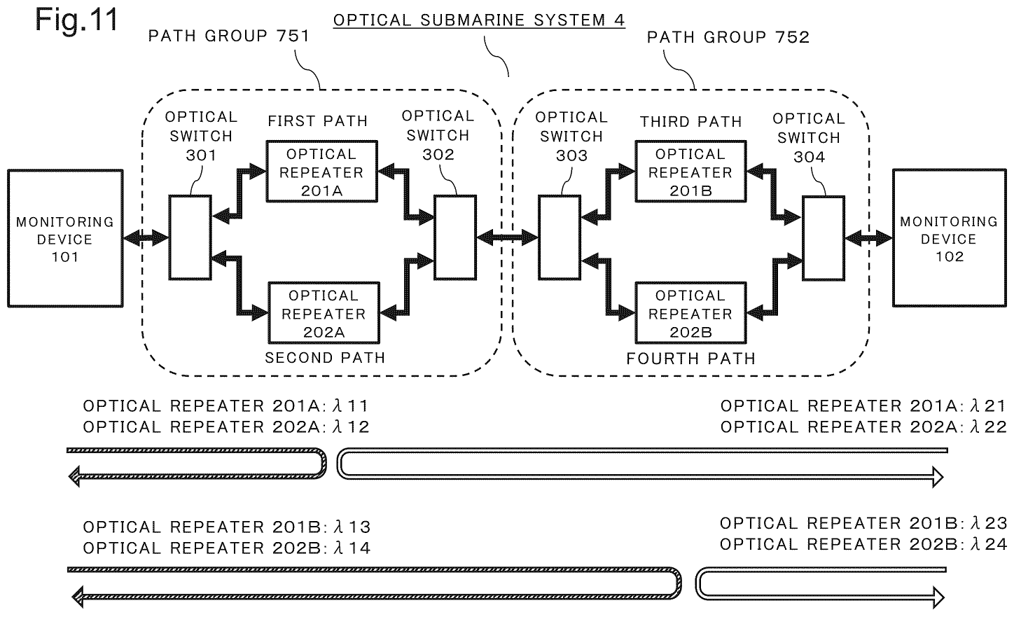

FIG. 11 is a diagram illustrating a configuration example of an optical submarine system 4 according to a fourth example embodiment of the present invention. As compared with the optical submarine system 2 in FIG. 7, the optical submarine system 4 is different in a point that two path groups 751 and 752 are included. In FIG. 11, a path group including a first path and a second path is described as the path group 751, and a path group including a third path and a fourth path is described as the path group 752. Further, in FIG. 11, description of optical transceivers 401 and 402, optical multiplexer/demultiplexers 411 and 412, and a data line 801 is omitted. Further, an optical fiber pair connecting between elements such as an optical repeater and an optical switch is described by using a thick straight line having an arrow on both ends.

The path group 751 has been described in the first example embodiment. The path group 752 is disposed between an optical switch 302 and a monitoring device 102. The path group 752 includes optical switches 303 and 304, and optical repeaters 201B and 202B.

Each of the optical switches 303 and 304, and the optical repeaters 201B and 202B includes a function similar to that of the optical switches 301 and 302, and the optical repeaters 201A and 202A described so far. Specifically, the optical switches 301 and 302 are operated in such a way as to select the first path or the second path, and the optical switches 303 and 304 are operated in such a way as to select the third path or the fourth path. In this way, the optical switches 301 and 302 select, as an active system, one path from among the path group 751. Further, the optical switches 303 and 304 select, as an active system, one path from among the path group 752.

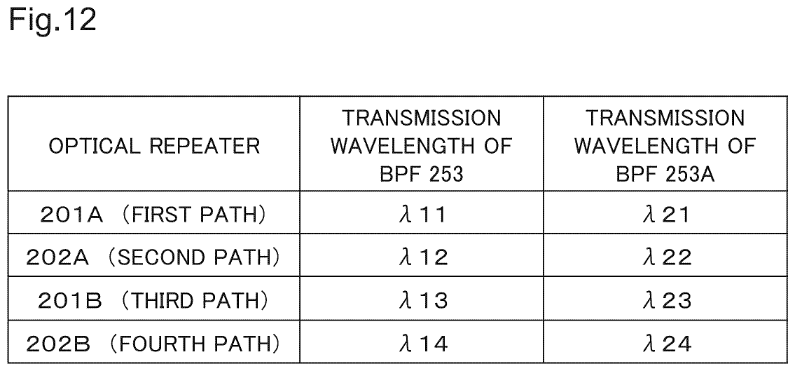

FIG. 12 is a table illustrating an example of a transmission wavelength of optical band pass filters 253 and 253A in each optical repeater in the present example embodiment. The optical band pass filter 253 is included in a loopback circuit 250 for looping back monitoring light transmitted by a monitoring device 101. The optical band pass filter 253 is included in a loopback circuit 250A for looping back monitoring light transmitted by the monitoring device 102.

Each of transmission wavelengths of the optical band pass filters 253 included in the optical repeaters 201A, 202A, 201B, and 202B is each λ11 , λ12, λ13, and λ14, and λ11 to λ14 are different from one another. Further, a transmission wavelength of the optical band pass filter 253A is each λ21 to λ2n, and λ21 to λ2n are different from one another. Then, the path group 751 loops back monitoring light of the wavelengths λ11 , λ12, λ21, and λ22. The path group 752 loops back monitoring light of the wavelengths λ13, λ14, λ23, and λ24. Setting transmission wavelengths of the optical band pass filters 253 and 253A as illustrated in FIG. 12 enables to identify an optical repeater in which monitoring light is looped back in each of the path groups, even when a plurality of path groups are connected in series.

As illustrated in a lower portion in FIG. 11, monitoring light of the wavelength λ11 transmitted by the monitoring device 101 is looped back by the optical repeater 201A, and monitoring light of the wavelength λ12 is looped back by the optical repeater 202A. Further, monitoring light of the wavelength λ13 transmitted by the monitoring device 101 is looped back by the optical repeater 201B, and monitoring light of the wavelength λ14 is looped back by the optical repeater 202B. For example, when a wavelength of monitoring light received by the monitoring device 101 is λ11 and λ14, the monitoring device 101 can identify that the first path is selected by the optical switches 301 and 302, and the fourth path is selected by the optical switch 303. Further, in this case, when a wavelength of monitoring light received by the monitoring device 102 is λ21 and λ24, the monitoring device 102 can identify that the fourth path is selected by the optical switches 303 and 304, and the first path is selected by the optical switch 302. Therefore, it is possible to identify that the optical switches 301 to 304 are operated in such a way as to select the first path and the fourth path.

On the other hand, when a wavelength of monitoring light received by the monitoring devices 101 and 102 indicates that different paths connected in parallel are selected, there is a possibility that any of the optical switches is not switched normally. For example, when monitoring light of the wavelength λ13 is received by the monitoring device 101 at a time of transmitting monitoring light by the monitoring device 101, the monitoring device 101 identifies that the optical switch 303 selects the third path. However, herein, when it is assumed that monitoring light of the wavelength λ24 is received by the monitoring device 102 at a time of transmitting monitoring light by the monitoring device 102, the monitoring device 102 identifies that the optical switch 304 selects the fourth path. In a case as described above, there is a possibility that at least one of the optical switches 303 and 304 is not operated normally.

In this way, the optical submarine system 4 can identify a path being selected in each of the path groups, even when the path groups 751 and 752 are connected in series. A reason for this is that a wavelength of monitoring light to be looped back in the same direction is different for each optical repeater, even between different path groups. This allows the monitoring devices 101 and 102 to identify a path group and an optical repeater in which monitoring light is looped back by measuring a wavelength of the looped back monitoring light.

### Modification Example of Fourth Example Embodiment

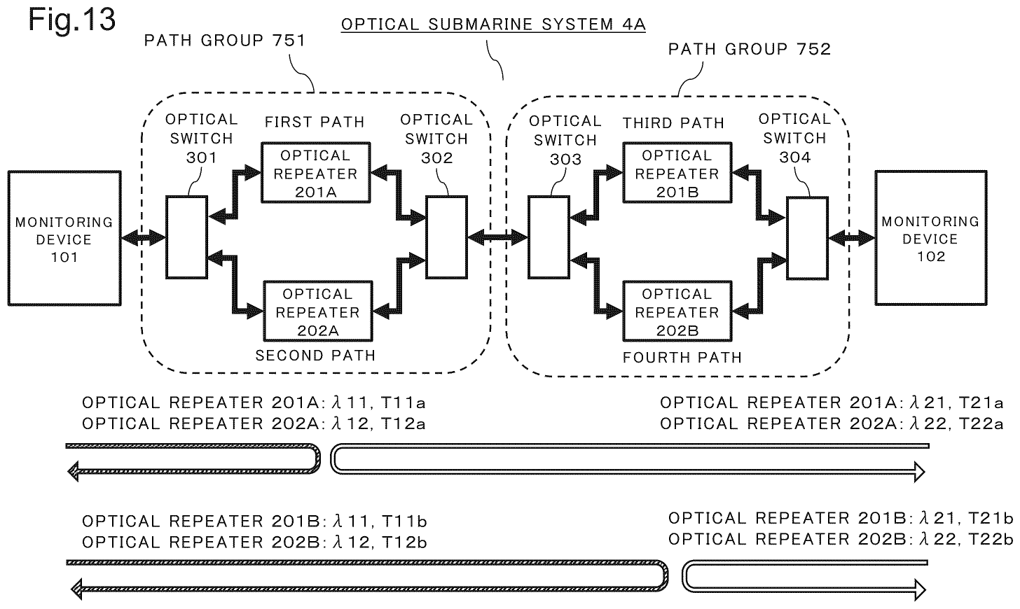

FIG. 13 is a diagram illustrating an optical submarine system 4A being a modification example of the fourth example embodiment. A configuration of each unit of the optical submarine system 4A is similar to that of the optical submarine system 4 in FIG. 11. However, a transmission wavelength of optical band pass filters 253 and 253A is different from that in the optical submarine system 4.

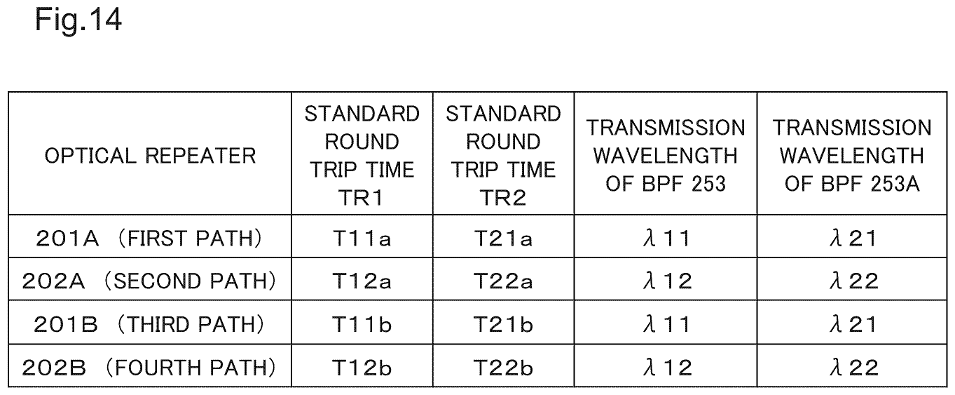

FIG. 14 is a table illustrating an example of a transmission wavelength of the optical band pass filters 253 and 253A in each optical repeater. A transmission wavelength of the optical band pass filter 253 included in optical repeaters 201A and 201B is all λ11, and a transmission wavelength of the optical band pass filter 253A included in the optical repeaters 201A and 201B is all λ21. Further, a transmission wavelength of the optical band pass filter 253 included in optical repeaters 202A and 202B is all λ12, and a transmission wavelength of the optical band pass filter 253A included in the optical repeaters 202A and 202B is all λ22. Specifically, in the present example embodiment, both of path groups 751 and 752 loop back any of beams of monitoring light of the wavelengths λ11, λ12, λ21, and λ22.

As will be described later, in the present modification example, a round trip time of monitoring light is utilized for identifying a path group in which monitoring light is looped back. A standard round trip time TR1 in FIG. 14 is a standard round trip time from a transmission time of monitoring light to a reception time of the monitoring light in a monitoring device 101. A standard round trip time TR2 is a standard time from a transmission time of monitoring light to a reception time of the monitoring light in a monitoring device 102. TR1 and TR2 may be derived based on a design-based distance between the monitoring devices 101 and 102, and each optical repeater, and a propagation speed of monitoring light. TR1 and TR2 do not have to be a strict value. TR1 and TR2 may have any value, as long as TR1 and TR2 have accuracy with which it is possible to determine to which one of TR1 and TR2, a round trip time TO of measured monitoring light is close.

In the present modification example, both of a wavelength of monitoring light looped back from a path group 751, and a wavelength of monitoring light looped back from a path group 752, being received in the monitoring device 101, are λ11 or λ12. Further, both of a wavelength of monitoring light looped back from the path group 751, and a wavelength of monitoring light looped back from the path group 752, being received in the monitoring device 102, are λ21 or λ22. Therefore, for example, when monitoring light is looped back in the optical repeaters 201A and 201B, the monitoring device 101 receives only monitoring light of the wavelength λ11. Therefore, the monitoring devices 101 and 102 need to know in which optical repeater of a path group, the received monitoring light is looped back.

In view of the above, in the present modification example, the monitoring devices 101 and 102 transmit pulsed light, as monitoring light. Pulsed light may be single pulsed light, or may be intermittent pulsed light. Then, a control unit 113 included in the monitoring devices 101 and 102 measures the round trip time T0 of transmitted monitoring light, and also determines in which one of the path groups 751 and 752, the monitoring light is looped back, based on the round trip time T0.

For example, a monitoring light transmission unit 111 illustrated in FIG. 2 transmits monitoring light, as pulsed light at a certain time T1, and notifies the control unit 113 of the time T1. A monitoring light reception unit 112 notifies the control unit 113 of a reception time T2 of the monitoring light. The control unit 113 derives the round trip time T0 of the monitoring light, as T2-T1. The control unit 113 compares the round trip time T0 of the received monitoring light with standard round trip times TR1 and TR2 associated with a wavelength of the monitoring light, and determines to which one of TR1 and TR2, T0 is close.

For example, when the monitoring device 101 receives monitoring light of the wavelength λ11, it is assumed that monitoring light is looped back in at least one of the optical repeaters 201 and 201B. Then, when the round trip time T0 of received pulsed light is closer to T11a than T11b, the control unit 113 of the monitoring device 101 can determine that the monitoring light is looped back in the optical repeater 201A. Further, when T0 is closer to T11b than T11a, it is possible to determine that the monitoring light is looped back in the optical repeater 201B. Furthermore, when both of monitoring light whose T0 is closer to T11a, and monitoring light whose T0 is closer to T11b are received, the control unit 113 may determine that monitoring light is looped back in the optical repeaters 201A and 201B. Also when the monitoring device 102 transmits pulsed light of the wavelengths λ21 and λ22, as monitoring light, it is possible to identify an optical repeater in which monitoring light is looped back by a similar procedure.

Herein, it is preferable to set a pulse length of monitoring light short in such a way as to prevent a reception time of a pulse of two beams of monitoring light to be received by the monitoring device 101 from overlapping in order to transmit monitoring light of one pulse and detect each of two beams of monitoring light looped back in each of two path groups. A pulse length as described above is easily set by general computation using a difference in standard round trip time between general two path groups.

As described above, similar to the optical submarine system 4, the optical submarine system 4A can identify a path being selected in each of the path groups, even when the path group 751 and the path group 752 are connected in series. Further, the optical submarine system 4A can identify a path group in which monitoring light is looped back by measuring a round trip time of the monitoring light. Therefore, in the optical submarine system 4A, a wavelength of monitoring light to be looped back in the path group 751, and a wavelength of monitoring light to be looped back in the path group 752 may overlap each other. Accordingly, as compared with the optical submarine system 4, the optical submarine system 4A achieves an advantageous effect that the number of wavelengths of monitoring light can be reduced, and thereby, an advantageous effect that a bandwidth of signal light transmitting user data can be expanded.

In the foregoing example embodiments, an optical submarine system has been described as an example. However, it is clear that a configuration of each example embodiment can also be applied to an optical transmission system on land. Further, any of the above-described advantageous effects can be acquired by combining a configuration of each example embodiments appropriately. For example, a configuration of the optical submarine system 3 including n paths being exemplified in FIG. 9 can also be applied to the optical submarine systems 4 and 4A exemplified in FIG. 11 and FIG. 13.

Further, the relay circuit 280 is not an essential element in the above-described example embodiments, and an advantageous effect of each of the example embodiments can be acquired, even when each optical repeater includes only a loopback circuit.

Note that, the example embodiments of the present invention may also be described as the following supplementary notes, but are not limited to the following.

### Supplementary Note 1

A path identification system including:

a path group being capable of selecting one active path from among paths being a plurality of optical transmission paths disposed in parallel; and

a monitoring means for transmitting and receiving monitoring light to and from the path group, wherein

the path group includes
a loopback means, disposed on each of the plurality of paths, for looping back only monitoring light of a wavelength being different from each other,
a first optical switching means for connecting any of one end of the plurality of paths to the monitoring means, and
a second optical switching means for selecting any of the other end of the plurality of paths, and

the monitoring means includes
a monitoring light transmission means for outputting the monitoring light to the first optical switching means,
a monitoring light reception means for receiving the monitoring light from the first optical switching means, and outputting wavelength information indicating a wavelength of the received monitoring light, and
a control means for identifying the loopback means in which the received monitoring light is looped back, based on the wavelength information, and loopback information in which a wavelength of the monitoring light to be looped back by the plurality of loopback means is recorded, and identifying, as the active path, a path on which the identified loopback means is disposed.

### Supplementary Note 2

The path identification system according to supplementary note 1, wherein

all of the plurality of loopback means are connected to a first optical transmission path connected to the first optical switching means, and a second optical transmission path connected to the second optical switching means, and

each of the plurality of loopback means includes
a first optical coupler for splitting light input from a first optical transmission path,
an optical filter to which one of beams of light input from the split first optical transmission path is input, and configured to transmit only the monitoring light of a predetermined wavelength, and
a second optical coupler for combining light input from the optical filter, and light input from the second optical transmission path, and outputting combined light to the first optical transmission path.

### Supplementary Note 3

The path identification system according to supplementary note 1 or 2, further including

a first path group and a second path group, each of which is the

path group being different from each other, wherein the second optical switching means included in the first path group and the first optical switching means included in the second path group are connected to each other, and

a wavelength of the monitoring light to be looped back by each of the loopback means included in the first path group and the second path group is all different.

### Supplementary Note 4

The path identification system according to any one of supplementary notes 1 to 3, wherein

the control means identifies, as the active path, a path on which the loopback means for looping back the monitoring light of a wavelength associated with the wavelength information is disposed.

### Supplementary Note 5

The path identification system according to supplementary note 1 or 2, further including

a first path group and a second path group, each of which is the path group being different from each other, wherein

the second optical switching means included in the first path group and the first optical switching means included in the second path group are connected to each other, and

the monitoring means
transmits the monitoring light, as pulsed light,
measures a round trip time of the pulsed light,
records, as included in the loopback information, a standard round trip time of the monitoring light between each of the loopback means included in the first path group and the second path group, and the monitoring means, and
identifies the path group in which the received monitoring light is looped back, based on the standard round trip time and the measured round trip time.

### Supplementary Note 6

The path identification system according to supplementary note 5, wherein

the control means
identifies, as a path group to be used as the active path, a path group in which the loopback means having the standard round trip time associated with the measured round trip time is disposed, and
identifies, as the active path, a path in which the loopback means for looping back the monitoring light of a wavelength associated with the wavelength information is disposed among the loopback means installed in the identified path group.

### Supplementary Note 7

The path identification system according to any one of supplementary notes 1 to 6, wherein

the loopback means is included inside an optical repeater disposed on each of the plurality of paths.

### Supplementary Note 8

The path identification system according to any one of supplementary notes 1 to 6, wherein

the loopback means is connected to an outside of an optical repeater disposed on each of the plurality of paths.

### Supplementary Note 9

A monitoring device including:

a monitoring light transmission means for outputting monitoring light to an optical transmission path;

a monitoring light reception means for receiving the monitoring light, and outputting wavelength information indicating a wavelength of the received monitoring light; and

a control means for holding loopback information in which a wavelength of the monitoring light to be looped back by a plurality of loopback means on the optical transmission path is recorded, identifying the loopback means in which the received monitoring light is looped back, based on the wavelength information and the loopback information, and identifying, as an active path, a path on which the identified loopback means is disposed.

### Supplementary Note 10

A path identification method for use in an optical transmission system including a path group being capable of selecting one active path from among paths being a plurality of optical transmission paths disposed in parallel, and a monitoring means for transmitting and receiving monitoring light to and from the path group, the path identification method including:

connecting any of one end of the plurality of paths to the monitoring means by a first optical switching means;

selecting any of the other end of the plurality of paths by a second optical switching means;

outputting the monitoring light to the first optical switching means;

looping back only the monitoring light of a wavelength being different from each other by a loopback means on each of the plurality of paths;

receiving the monitoring light from the first optical switching means, and outputting wavelength information indicating a wavelength of the received monitoring light;

identifying the loopback means in which the received monitoring light is looped back, based on the wavelength information, and loopback information in which a wavelength of the monitoring light to be looped back by the plurality of loopback means is recorded; and

identifying, as the active path, a path on which the identified loopback means is disposed.

### Supplementary Note 11

The path identification method according to supplementary note 10 for use in the optical transmission system including a first path group and a second path group, each of which is the path group being different from each other, the path identification method further including

connecting the second optical switching means included in the first path group and the first optical switching means included in the second path group to each other, wherein

a wavelength of the monitoring light to be looped back by each of the loopback means included in the first path group and the second path group is all different.

### Supplementary Note 12

The path identification method according to supplementary note 10 or 11, further including

identifying, as the active path, a path on which the loopback means for looping back the monitoring light of a wavelength associated with the wavelength information is disposed.

### Supplementary Note 13

The path identification method according to supplementary note 10 for use in the optical transmission system including a first path group and a second path group, each of which is the path group being different from each other, the path identification method further including:

connecting the second optical switching means included in the first path group and the first optical switching means included in the second path group to each other;

recording, as included in the loopback information, a standard round trip time of the monitoring light between each of the loopback means included in the first path group and the second path group, and the monitoring means;

transmitting the monitoring light, as pulsed light;

measuring a round trip time of the pulsed light; and

identifying the path group in which the received monitoring light is looped back, based on the standard round trip time and the measured round trip time.

### Supplementary Note 14

The path identification method according to supplementary note 13, further comprising:

identifying, as the path group to be used as the active path, a path group in which the loopback means having the standard round trip time associated with the measured round trip time is disposed; and

identifying, as the active path, a path on which the loopback means for looping back the monitoring light of a wavelength associated with the wavelength information is disposed among the loopback means disposed in the identified path group.

### Supplementary Note 15

A monitoring device control method including:

outputting monitoring light to an optical transmission path;

receiving the monitoring light;

outputting wavelength information indicating a wavelength of the received monitoring light; and

identifying a loopback means in which the received monitoring light is looped back, based on loopback information in which a wavelength of the monitoring light to be looped back by a plurality of the loopback means on the optical transmission path is recorded, and the wavelength information, and identifying, as an active path, a path on which the identified loopback means is disposed.

Supplementary note 16

A recording medium recorded with a program for causing a computer of a monitoring device to execute:

a procedure of outputting monitoring light to an optical transmission path;

a procedure of receiving the monitoring light;

a procedure of outputting wavelength information indicating a wavelength of the received monitoring light;

a procedure of recording, as loopback information, a wavelength of the monitoring light to be looped back by a plurality of loopback means on the optical transmission path;

a procedure of identifying the loopback means in which the received monitoring light is looped back, based on the loopback information and the wavelength information; and

a procedure of identifying, as an active path, a path on which the identified loopback means is disposed.

While the invention has been particularly shown and described with reference to exemplary embodiments thereof, the invention is not limited to these embodiments. It will be understood by those of ordinary skill in the art that various changes in form and details may be made therein without departing from the spirt and scope of the present invention as defined by the claims.

For example, functions of the monitoring devices 101 and 102 may be programmed. Then, the monitoring devices 101 and 102 may achieve a part or all of the functions included in the monitoring devices 101 and 102 by causing a computer to execute the program. The computer is, for example, a logical device, a central processing device, or a digital signal processing device. The computer may be included in the control unit 113. Further, the program may be recorded in a computer-readable, fixed non-transitory recording medium. The recording medium is, for example, a flexible disc, a fixed magnetic disk, or a non-volatile semiconductor memory. The program may be distributed to the monitoring devices 101 and 102 via a network.

Further, a configuration described in each of the example embodiments is not necessarily mutually exclusive. An advantageous effect of the present invention may be achieved by a configuration in which all or a part of the above-described example embodiments is combined.

### REFERENCE SIGNS LIST

1, 1A, 2, 3, 4, 4A Optical submarine system
11, 12, 21, 22, 31, 32, 114 Fiber pair
21A, 21B, 31A, 31B Optical fiber
101, 101A, 102 Monitoring device
111, 111A Monitoring light transmission unit
112 Monitoring light reception unit
113 Control unit
201, 201A, 201B, 202, 202A, 202B Optical repeater
212 Light
250, 250A Loopback circuit
251, 251A, 252, 252A Optical coupler
253, 253A Optical band pass filter (BPF)
280 Relay circuit
301 to 304, 311, 312 Optical switch
401, 402 Optical transceiver
411, 412 Optical multiplexer/demultiplexer
511 ASE light source
513 Optical band pass filter
701 Monitoring light
702, 802 Signal light
721 Downstream light
821 Upstream light
750, 751, 752 Path group
801 Data line

What is claimed is:

1. A path identification system comprising:
a path group being capable of selecting one active path from among paths being a plurality of optical transmission paths disposed in parallel; and
a monitor configured to transmit and receive monitoring light to and from the path group, wherein
the path group includes
loopback circuits, disposed on each of the plurality of paths, configured to loop back only monitoring light of a wavelength being different from each other,
a first optical switch configured to connect any of one end of the plurality of paths to the monitor, and
a second optical switch configured to select any of the other end of the plurality of paths, and
the monitor includes
a monitoring light transmitter configured to output the monitoring light to the first optical switch,
a monitoring light receiver configured to receive the monitoring light from the first optical switch, and output wavelength information indicating a wavelength of the received monitoring light, and
a controller configured to identify a loopback circuit in which the received monitoring light is looped back, based on loopback information in which a wavelength of the monitoring light to be looped back by the plurality of loopback circuits is recorded and the wavelength information, and identify, as the active path, a path on which the identified loopback circuit is disposed.

2. The path identification system according to claim 1, wherein
all of the plurality of loopback circuits are connected to a first optical transmission path connected to the first optical switch, and a second optical transmission path connected to the second optical switch, and
each of the plurality of loopback circuits includes
a first optical coupler configured to split light input from a first optical transmission path,
an optical filter to which one of beams of light input from the split first optical transmission path is input, and configured to transmit only the monitoring light of a predetermined wavelength, and
a second optical coupler configured to combine light input from the optical filter, and light input from the second optical transmission path, and output combined light to the first optical transmission path.

3. The path identification system according to claim 1, further comprising
a first path group and a second path group, each of which is the path group being different from each other, wherein
the second optical switch included in the first path group and the first optical switch included in the second path group are connected to each other, and
a wavelength of the monitoring light to be looped back by each of the loopback circuits included in the first path group and the second path group is all different.

4. The path identification system according to claim 1, wherein
the controller identifies, as the active path, a path on which a loopback circuit configured to loop back the monitoring light of a wavelength associated with the wavelength information is disposed.

5. The path identification system according to claim 1, further comprising
a first path group and a second path group, each of which is the path group being different from each other, wherein
the second optical switch included in the first path group and the first optical switch included in the second path group are connected to each other, and
the monitor
transmits the monitoring light, as pulsed light,
measures a round trip time of the pulsed light,
records, as included in the loopback information, a standard round trip time of the monitoring light between each of the loopback circuits included in the first path group and the second path group, and the monitor, and
identifies the path group in which the received monitoring light is looped back, based on the standard round trip time and the measured round trip time.

6. The path identification system according to claim 5, wherein
the controller
identifies, as a path group to be used as the active path, a path group in which a loopback circuit having the standard round trip time associated with the measured round trip time is disposed, and
identifies, as the active path, a path in which the loopback circuit configured to loop back the monitoring light of a wavelength associated with the wavelength information is disposed among the loopback circuits installed in the identified path group.

7. The path identification system according to claim 1, wherein
the loopback circuits are included inside an optical repeater disposed on each of the plurality of paths.

8. The path identification system according to claim 1 wherein
the loopback circuits are connected to an outside of an optical repeater disposed on each of the plurality of paths.

9. A monitoring device comprising:
a monitoring light transmitter configured to output monitoring light to an optical transmission path;
a monitoring light receiver configured to receive the monitoring light, and output wavelength information indicating a wavelength of the received monitoring light; and
a controller configured to hold loopback information in which a wavelength of the monitoring light to be looped back by a plurality of loopback circuits on the optical transmission path is recorded, identifying a loopback circuit in which the received monitoring light is looped back, based on the wavelength information and the loopback information, and identifying, as an active path, a path on which the identified loopback circuit is disposed.

10. A path identification method for use in an optical transmission system including a path group being capable of selecting one active path from among paths being a plurality of optical transmission paths disposed in parallel, and a monitor configured to transmit and receive monitoring light to and from the path group, the path identification method comprising:
connecting any of one end of the plurality of paths to the monitor by first optical switch;
selecting any of the other end of the plurality of paths by second optical switch;
outputting the monitoring light to the first optical switch;
looping back only the monitoring light of a wavelength being different from each other by a loopback circuit on each of the plurality of paths;
receiving the monitoring light from the first optical switch, and outputting wavelength information indicating a wavelength of the received monitoring light;
identifying a loopback circuit in which the received monitoring light is looped back, based on loopback information in which a wavelength of the monitoring light to be looped back by the plurality of loopback circuits is recorded and the wavelength information; and
identifying, as the active path, a path on which the identified loopback circuit is disposed.

11. The path identification method according to claim 10 for use in the optical transmission system including a first path group and a second path group, each of which is the path group being different from each other, the path identification method further comprising
connecting the second optical switch included in the first path group and the first optical switch included in the second path group to each other, wherein
a wavelength of the monitoring light to be looped back by each of the loopback circuits included in the first path group and the second path group is all different.

12. The path identification method according to claim 10, further comprising identifying, as the active path, a path on which a loopback circuit configured to loop back the monitoring light of a wavelength associated with the wavelength information is disposed.

13. The path identification method according to claim 10 for use in the optical transmission system including a first path group and a second path group, each of which is the path group being different from each other, the path identification method further comprising:
connecting the second optical switch included in the first path group and the first optical switch included in the second path group to each other;
recording, as included in the loopback information, a standard round trip time of the monitoring light between each of the loopback circuits included in the first path group and the second path group, and the monitor;
transmitting the monitoring light, as pulsed light;
measuring a round trip time of the pulsed light; and
identifying the path group in which the received monitoring light is looped back, based on the standard round trip time and the measured round trip time.

14. The path identification method according to claim 13, further comprising:
identifying, as the path group to be used as the active path, a path group in which a loopback circuit having the standard round trip time associated with the measured round trip time is disposed; and
identifying, as the active path, a path on which a loopback circuit configured to loop back the monitoring light of a wavelength associated with the wavelength information is disposed among the loopback circuits disposed in the identified path group.

15-16. (canceled)
